(19) United States
(12) Patent Application Publication
(10) Pub. No.: US 2021/0186265 A1
(43) Pub. Date: Jun. 24, 2021

(54) Multi-pass Fryer Heat Exchanger

(71) Applicant: Laxminarasimhan Vasan, Diamond Bar, CA (US)

(72) Inventor: Laxminarasimhan Vasan, Diamond Bar, CA (US)

(21) Appl. No.: 16/720,454

(22) Filed: Dec. 19, 2019

(51) Int. Cl. A47J 37/12

(52) U.S. Cl. CPC A47J 37/1247; A47J 37/1271

(57) ABSTRACT

Improvements in a multi-pass fryer heat exchanger that has three passes through heating tubes to heat cooking oil. The first pass includes diffusers in each tube to disrupt the laminar flow of the ignited gas and spreads the heat outward to the inside diameter of the first pass. The turbulent flow of hot flue product is disrupted as the flue product enters each collection box. A bi-metal heat sink in each collection box creates a thermal mass that retains heat and dissipates to the cooking oil. The thermal mass stores heat and reduces the number of on-off cycle by storing and transferring heat within the bi-metal heat sink into the oil. The second and third pass uses a progressive reduction in the tube diameter with each pass of tube that increases the velocity of the flue product in each pass.

### CROSS REFERENCE TO RELATED APPLICATION

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a heat exchanger for use in a deep fryer. More particularly, the present multi-pass fryer heat exchanger creates a heat exchanger with an increased thermal mass that more evenly provides constant even heat over an extended period of time.

### Description of Related Art Including Information Disclosed Under 37 CFR 1.97 and 1.98

Deep fryers are used to fry a variety of foods in a vat of cooking oil or shortening. The food is placed into a basket where the heated cooking oil can pass through the basket and around the food that is immersed in the oil. The cooking oil is heated with a heating system or heat exchanger that is often a gas burner. The gas burner is cycled to maintain the temperature of the oil. It is also important to maintain an even temperature across the entire vat so all of the food in the basket is evenly fried.

A number of patents and or publications have been made to address these issues. Exemplary examples of patents and or publication that try to address this/these problem(s) are identified and discussed below.

U.S. Pat. No. 5,417,202 issued on May 23, 1995 to Joseph A. C. Cote and is titled Gas Fryer Heat Exchanger. This patent discloses a heat exchanger for a fryer having a vat or tank filled to a selected level with a cooking medium such as shortening or oil. The heat exchanger includes a plurality of heat transfer tubes each having an inlet end and an outlet end, and at least one of the plurality of heat transfer tubes extending at a first angle, at least one of the plurality of heat transfer tubes extending at a second angle generally opposite to the first angle, and at least one of the plurality of heat transfer tubes extending horizontally. While this patent discloses a heat exchanger, the heating tubes are a constant diameter and the heating is not consistent.

U.S. Pat. No. 6,016,799 issued on Jan. 25, 2000 to Albert Charles McNamara and is titled Vortex Chamber for Deep Fryer Heat Exchanger. This patent discloses a heat exchanger has a plurality of heat transfer conduits and a heating means for heating fluid flowing through the heat transfer conduits. At least one vortex chamber has at least one inlet opening, at least one outlet opening, and, preferably, at least one baffle positioned therein. A first portion of at least one heat transfer conduit is sealingly connected to a respective inlet opening of a vortex chamber. A second portion of the at least one heat transfer conduit is sealingly connected to a respective outlet opening of the vortex chamber. This patent uses baffles to disrupt the flow of hot gas, but does not include a thermal mass.

U.S. Pat. No. 8,905,015 issued on Dec. 9, 2014 to Hideo Chikazawa et al. and is titled Pulse Burner and Liquid Heating Cooker. This patent discloses a pulse burner includes: a combustion chamber provided in a liquid vat capable of storing liquid; a tail pipe that is connected to the combustion chamber and has a heat exchanging portion located in the liquid vat and bent in a predetermined shape; and a mixing chamber which communicates with the combustion chamber and to which fuel gas and combustion air is allowed to be supplied. When mixed gas including the fuel gas and the combustion gas is exploded and combusted, the combustion exhaust gas is exhausted through the tail pipe to allow heat exchange with the liquid, and the mixed gas is inhaled from the mixing chamber into the combustion chamber. This patent uses pulsed heating but does not provide a thermal mass and the temperature from the beginning to the end of the heat exchanger is not consistent.

U.S. Pat. No. 9,380,912 issued on Jul. 5, 2016 to Richard B. Manson and is titled Fryer and Associated Heat Exchange System. This patent discloses a fryer unit includes a vat and heat exchange system with multiple passes within the fryer vat. Additional heat exchange passes may be provided in ductwork along the exterior surface of the lateral vat sidewall. In this patent there is no mechanism to extend the heating after the gas is turned off.

What is needed is a heat exchanger that provides even heating and provides heat over an extended period of time. The multi-pass fryer heat exchanger disclosed in this document provides the solution.

### BRIEF SUMMARY OF THE INVENTION

It is an object of the multi-pass fryer heat exchanger to include three passes through heating tubes. The use of multiple tubes increases the surface area where the heat is transferred into the cooking oil and therefore increases the efficiency of the fryer to extract the optimal amount of heat transfer from the gas burner. In each pass the directional flow the flue product is changed or rotated 180 degrees as the flue product enters into each collection boxes and then makes another turn and passes into a subsequent tube pass.

It is an object of the multi-pass fryer heat exchanger to include diffusers in each tube in the first pass. The diffusers ensure maximum heat transfer though the first pass tubes. The diffusers disrupt the laminar flow of the ignited gas and spreads the heat outward to the inside diameter of the tube in the first pass. The turbulent flow of hot flue product is further disrupted as the flue product enters each collection box.

It is another object of the multi-pass fryer heat exchanger to use a progressively reduction in the tube diameter with each pass of tube. The reduction in the interior cross-sectional area increases the velocity of the hot air and gas in each pass. The hot air and gas of the flue product is “squeezed” through increasingly less area cross-sectional area and increases the speed of the flow through each pass and creates some back pressure in the heat exchanger.

It is another object of the multi-pass fryer heat exchanger to include a bi-metal (heat sink) in each of the collection boxes, between the 1st and 2^{nd} pass and the 2^{nd} and 3^{rd} pass. The bi-metal heat sink creates a thermal mass that retains heat and dissipates through the collection box wall to the medium (oil). Because the gas burner is cycled on when the oil is below a temperature threshold and is cycled off when the oil is above a temperature threshold the bi-metal heat sink increases the off-time cycle by storing and transferring heat within the bi-metal heat sink, conducting the heat into the tubes and into the oil. Without the thermal bi-metal mass, only the heated oil retains heat.

It is still another object of the multi-pass fryer heat exchanger to distributed load to reduces thermal stress in each of the tubes and collection box. Because the heating is cycled based upon the temperature of the cooling oil and not the flame temperature of the wall temperature of the heat exchanger, using a larger thermal mass in the heat exchanger allows the heat exchanger to dissipate heat into the oil after the flame has been turned off.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the multi-pass fryer heat exchanger.

FIG. 2 shows a perspective view of a deep fryer with the multi-pass fryer heat exchanger.

FIG. 3 shows a cross-sectional view of the multi-pass fryer heat exchanger.

FIG. 4 shows flow of the flue product through the multi-pass fryer heat exchanger.

FIG. 5 shows a graph of the flue product velocity through the multi-pass fryer heat exchanger.

FIG. 6 shows a graph of a comparison of the heating cycle with and without a heat sink.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

Item Numbers and Description

| | |
|---|---|
| 20 multi-pass fryer heat exchanger | 21 fryer enclosure |
| 22 basket(s) | 23 oil vat |
| 24 exhaust hood | 25 rolling caster |
| 26 locking caster | 27 user interface |
| 30 first pass tube(s) | 31 baffle |
| 32 flame path | 33 first pass flow |
| 40 second pass tube(s) | 41 second pass flow |
| 50 third pass tube(s) | 51 third flow path |
| 60 first collection box | 61 first thermal mass |
| 62 enters first collection box | 63 direction change |
| 70 second collection box | 71 second thermal mass |
| 72 enters second collection box | 73 direction change |
| 80 flame tube | 81 gas tube |
| 82 exhaust | 83 air intake |
| 90 into | 101 start |
| 102 without heatsink | 103 with heatsink |
| 104 upper set point | 105 lower set point. |

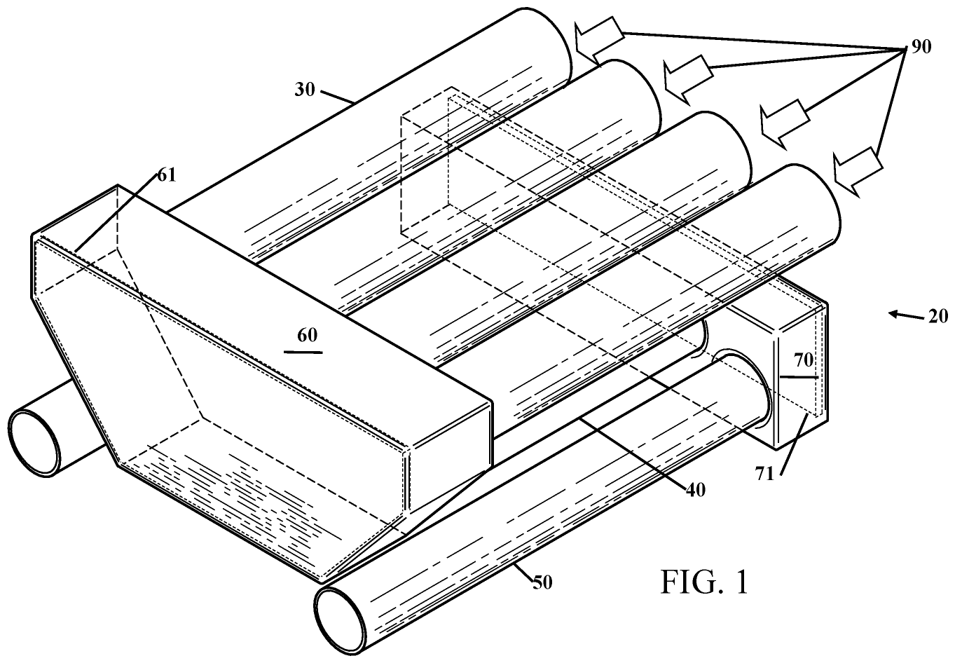

FIG. 1 shows a perspective view of a multi-pass fryer heat exchanger 20 in a preferred embodiment. As a general understanding of the multi-pass fryer heat exchanger 20, one or a plurality of gas burners ignite natural gas that flames near and/or into the first pass tubes 30. While the embodiment shows four first pass tubes, more or less than four tubes are contemplated. The diameter and quantity of the first pass tubes is selected based upon the desired amount of heating that is desired/required. Flue product from the burners pass through the first pass tubes 30 and is collected and co-mingled in a first collection box 60. Within the end of the first collection box 60 is a first thermal mass 61 or bi-metal member. A more detailed description of the thermal mass(es) is shown and described in other figures herein. The collection boxes not only transfer heat from the flue product to other pass tubes, but also more evenly distribute heat from the first pass tubes 30 to the second pass tubes 40.

In the preferred embodiment there are four first pass tubes 30 and three second pass tubes 40. While there are less tubes in the second pass, the diameter of the second pass tubes can be smaller diameter to increase the velocity of the flue product. After the second pass tubes 40 is a second collection box 70 with its own second thermal mass 71. The thermal mass is a dissimilar material from the tubes and collection boxes. Flue product from the second pass tubes 40 and is collected and co-mingled in a second collection box 70. After the second collection box 70 is a third pass tube(s) 50. In the preferred embodiment there can be two or three second pass tubes 40 and two third pass tubes 50. While there can be less tubes in the third pass, the diameter of the second pass tubes can be smaller diameter to increase the velocity of the flue product, as well as less or smaller diameter tubes in the third pass. The multi-pass fryer heat exchanger 20 is oriented in the fryer with the first pass tube at the top of the exchanger and the flue product travels downward in the collection boxes 60 and 70. This also ensures that any debris or soot is pushed downward and out of the tubes or collection boxes.

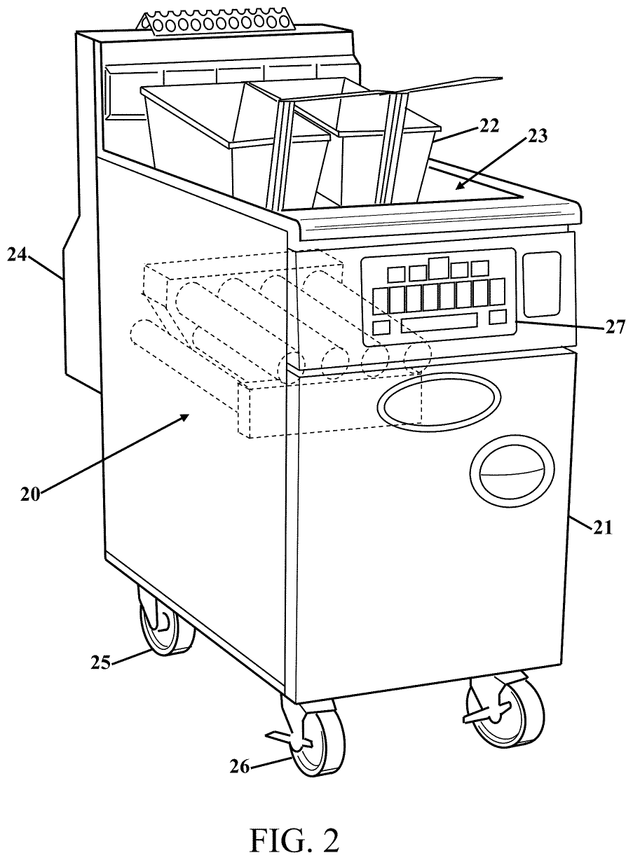

FIG. 2 shows a perspective view of a deep fryer with the multi-pass fryer heat exchanger 20. This figure shows a typical embodiment with the multi-pass fryer heat exchanger 20 within a fryer enclosure 21. There is an oil vat 23 where the multi-pass fryer heat exchanger 20 heats the oil within the oil vat 23 to the desired temperature. A user interface 27 provides a display of the temperature of the cooking oil and allows a user to select a desired cooking temperature or select a preset cooking temperature. Fries, onion rings or other food that will be fried are placed into a basket(s) 22 and immersed into the oil vat 23. A timer may be used or included to provide an indicator that the proper frying time has been achieved. The rear of the deep fryer has an exhaust hood 24 or ducting that directs flue product that has passed through the multi-pass fryer heat exchanger 20. The deep fryer may be supported on a plurality of rolling caster(s) 25 and or locking caster(s) 26.

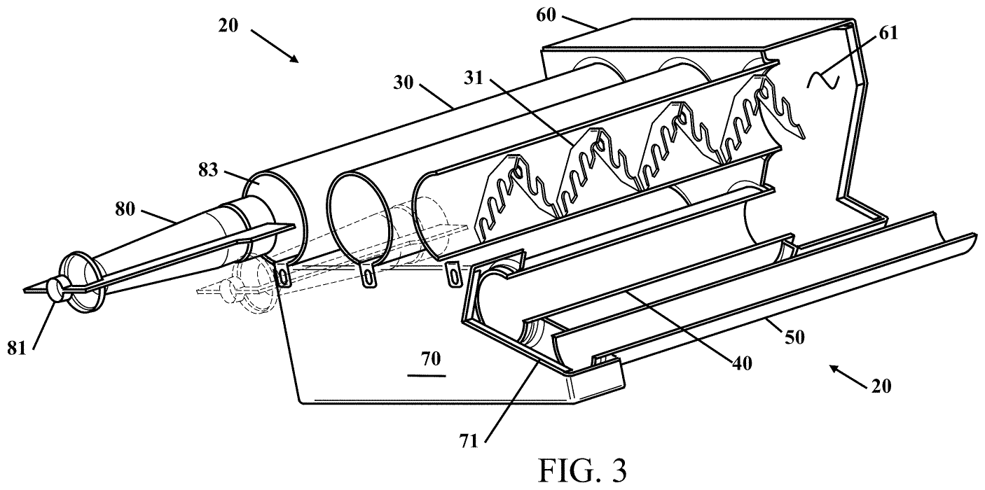

FIG. 3 shows a cross-sectional view of the multi-pass fryer heat exchanger 20. In this figure, one of the flame tubes 80 is shown with a second flame tube shown in broken lines. It should be understood that there will be flame tubes associated with each first pass tube 30. Gas enters a gas tube 81 and is ignited. The flame from natural gas burns at about 1,960° F. Air is drawn into the air intake and a flame enters into the first tube 30. In this partial cross-sectional view one of the first tubes 30 is shown with diffusers or baffles 31. The diffusers ensure maximum heat transfer though the first pass tubes 30. The diffusers or baffles 31 disrupt the laminar flow of the ignited gas and spreads the heat outward to the inside diameter of the first pass tubes 30. The turbulent flow of hot flue product is further disrupted as the flue product enters each collection box 60 or 70. The tubes and collection box are typically fabricated from a stainless steel. The stainless-steel material can be fairly thin and has a thermal conductivity of about 14.3 W/m K and a heat capacity of about 0.120 Btu/(lb-° F.). As a reference, the heating capacity of the oil 0.4 Btu/(lb-° F.) depending upon temperature.

While the embodiment shows four first pass tubes 30, more or less than four tubes are contemplated. The diameter and quantity of the first pass tubes is selected based upon the desired amount of heating that is desired/required. Flue product from the burners pass through the first pass tubes 30 and is collected and co-mingled in a first collection box 60. At the end of the first collection box 60 is a first thermal mass 61 or bi-metal member. The bi-metal member is preferably made from a carbon steel. Carbon steel has a heat capacity of about 0.120 Btu/(lb-°F.). In the embodiment shown the first thermal mass 61 is a plate having a thickness of about 0.25 inches thick and a volume of about 13 cubic inches or about 3.8 pounds. The thickness of the one or both thermal mass 61 and 71 can be changed to increase or decrease the amount of heat that can be stored in the thermal mass. It is contemplated that the thermal mass can range from 10 to 100 cubic inches. While minimal heat is stored in the walls of the tubes and collection boxes, the thermal mass 61 and 71 are heated and can dissipate heat into the tubes and collection boxes after the heating flame is off. The thermal mass can also absorb heat more quickly than the oil and can obtain a higher temperature than the oil.

The collection boxes not only transfer flue product to other pass tubes, but also more evenly distribute heat from the first pass tubes 30 to the second pass tubes 40. In the preferred embodiment there are four first pass tubes 30 and three second pass tubes 40. While there are less tubes in the second pass, the diameter of the second pass tubes can be smaller diameter to increase the velocity of the flue product. After the second pass tubes 40 is a second collection box 70 with its own second thermal mass 71. Flue product from the second pass tubes 40 and is collected and co-mingled in a second collection box 70. After the second collection box 70 is a third pass tube(s) 50. In the preferred embodiment there are three second pass tubes 40 and two third pass tubes 50. While there are less tubes in the third pass, the diameter of the second pass tubes can be smaller diameter to increase the velocity of the flue product. The multi-pass fryer heat exchanger 20 is oriented in the fryer with the first pass tube at the top of the exchanger and the flue product travels downward in the collection boxes 60 and 70. The second pass tubes 40 and the third pass tubes 50 may or may not include diffusers or baffles 31.

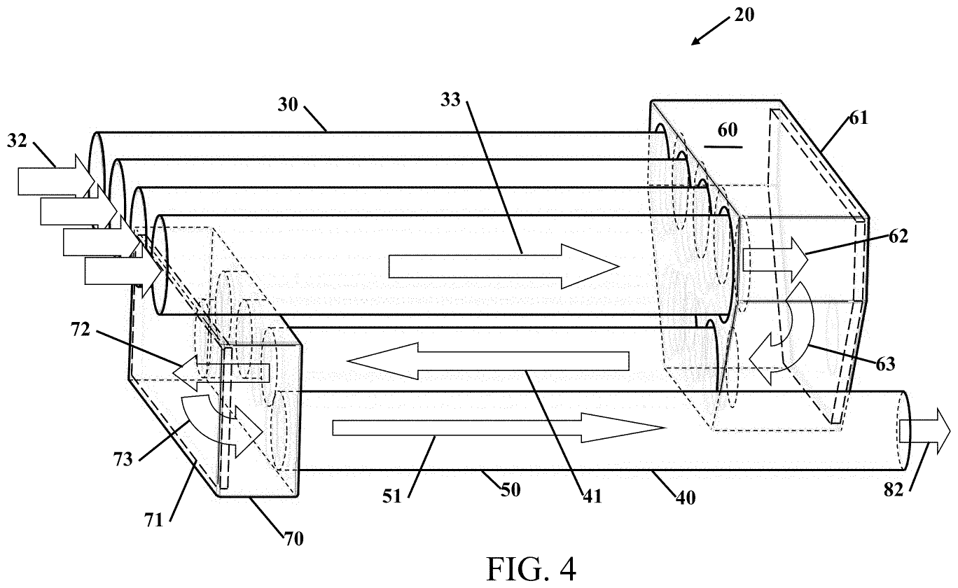

FIG. 4 shows flow of the flue product through the multi-pass fryer heat exchanger 20. This figure shows a pictorial diagram of the flame path 32 of the flue product entering from the four burners pass as it passes through the first pass tubes 30 and enters the first collection box 62 where it is collected and co-mingled in a first collection box 60. At the end of the first collection box 60 is a first thermal mass 61 or bi-metal member. The collection boxes not only transfer flue product to other pass tubes, but also more evenly distribute heat from the first pass tubes 30, changes direction in the 63 in the first collection box 80 and enters into the second pass tubes 40.

In the preferred embodiment there are four first pass tubes 30 and three second pass tubes 40. While there are less tubes in the second pass, the diameter of the second pass tubes can be smaller diameter to increase the velocity of the flue product. The flew product moves through the second flow path 41 and enters the second collection box 72. After the second pass tubes 40 is a second collection box 70 with its own second thermal mass 71. Flue product from the second pass tubes 40 and is collected and co-mingled in a second collection box 70. The collection boxes not only transfer flue product to other pass tubes, and again more evenly distribute heat from the second pass tubes 40, changes direction in the 73 in the second collection box 70 and enters into the third pass tubes 50.

After the second collection box 70 is a third pass tube(s) 50 as a third flow path 51. In the preferred embodiment there are three second pass tubes 40 and two third pass tubes 50. While there can be less tubes in the third pass, the diameter of the second pass tubes can be smaller diameter to increase the velocity of the flue product, as well as less or smaller diameter tubes in the third pass. The multi-pass fryer heat exchanger 20 is oriented in the fryer with the first pass tube at the top of the exchanger and the flue product travels downward in the collection boxes 60 and 70. All of the tubes and collection boxes are in the oil vat and transfer heat to the oil vat.

In the preferred embodiment the four first pass tubes 30 have a cross-sectional area of about 18 square inches, but it is contemplated that the cross-sectional area can range from 4 square inches to 40 square inches. The three second pass tubes 40 have a combined cross-sectional area of about 8 square inches, but it is contemplated that the cross-sectional area can range from 4 square inches to 20 square inches. The two third pass tubes 50 have a combined cross-sectional area of about 6 square inches, but it is contemplated that the cross-sectional area can range from 3 square inches to 20 square inches. While the tubes are shown as being round, it is also contemplated that the tubes can be ellipse as opposed to round.

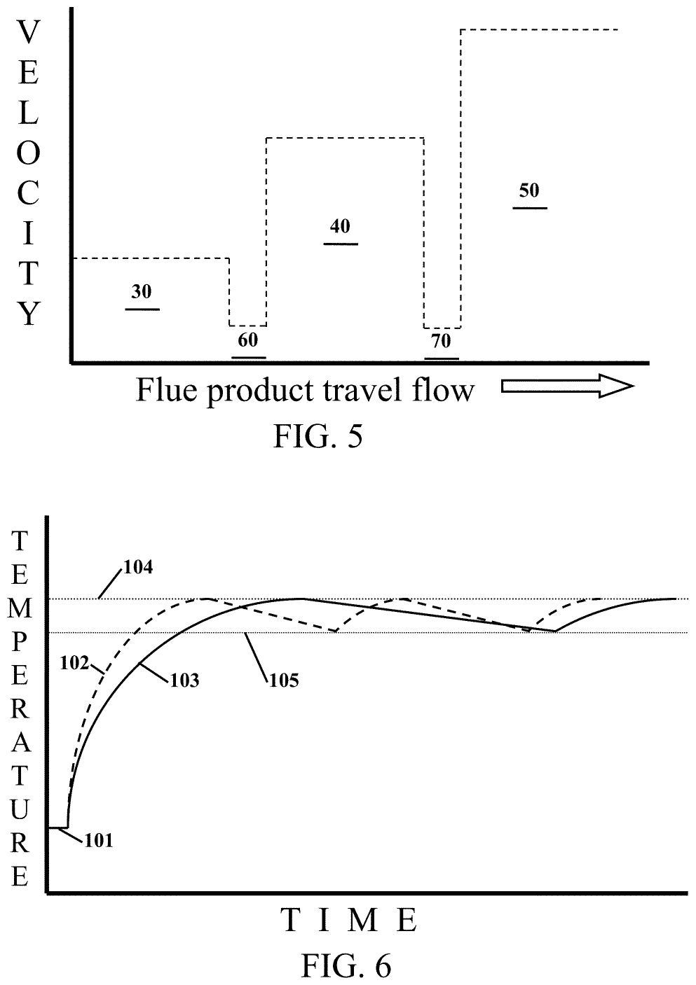

FIG. 5 shows a graph of the flue product velocity through the multi-pass fryer heat exchanger. The flue product travel flows from left to right across the X-axis in this figure. The vertical or Y-axis of the graph shows a relative velocity of the flue product. The velocity is essentially and inverse of the cross-sectional area of the tubes and collection boxes. Starting from the first pass tubes 30. Due to the increased cross-sectional volume of the first collection box 60 the velocity of the flue product slows as the flue product from all of the first pass tubes comingle. The flue product then enters the second pass tubes 40 that are smaller in diameter and significantly increases in velocity. The decreased cross-sectional area also creates some back-pressure to control the burn of the flue product in the first pass tubes 30.

As the flue product enters into the second collection box 70 the larger volume of the second collection box slows the velocity of the flue product. The cross-sectional area of the third pass tubes 50 is smaller than the first and second pass tubes so the velocity will again increase in velocity. The change in the direction of flow in the collection boxes also creates some back-pressure.

FIG. 6 shows a graph of a comparison of the heating cycle with and without a heatsink or thermal mass. Time is shown in the horizontal X axis of this graph and temperature is vertical or Y axis. When heating the oil there is an upper set point 104 and a lower set point 105 where the temperature of the oil is maintained. In the graph, the deep fryer is started 101 where the cooking oil is at room temperature. Without a heatsink 102 the cooking oil will heat more quickly and will also require more frequent thermal cycling. With a heatsink 103 the heatsink(s) will retain heat from the burners and the heat that is stored in the heatsink(s) will transfer the stored heat into the cooking oil. This will reduce the frequency that the burners are activated. While the graph shows the burners completely on or off, in the case of multiple heating tubes, one, multiple or all of the burners can be operated to maintain the temperature of the cooking oil.

Thus, specific embodiments of a multi-pass fryer heat exchanger have been disclosed. It should be apparent, however, to those skilled in the art that many more modifications besides those described are possible without departing from the inventive concepts herein. The inventive subject matter, therefore, is not to be restricted except in the spirit of the appended claims.

1. A multi-pass fryer heat exchanger comprising:
a plurality of first pass tubes;
said plurality of first pass tubes having an inlet for a flame tube;
said plurality of first pass tubes having an outlet that connection to an inlet to a first collection box;
said first collection box having a first thermal mass within said first collection box;
said first collection box having at least one outlet that connects to an inlet to at least one second pass tube;
said at least one second pass tube having an outlet that connects to an inlet to a second collection box;
said second collection box having at least one outlet that connects to an inlet to at least one third pass tube, and
said at least one third pass tube has an outlet.

2. The multi-pass fryer heat exchanger according to claim 1, wherein there are at least four first pass tubes.

3. The multi-pass fryer heat exchanger according to claim 2, wherein there are at least three first pass tubes.

4. The multi-pass fryer heat exchanger according to claim 3, wherein there are at least two first pass tubes.

5. The multi-pass fryer heat exchanger according to claim 1, wherein there is a second thermal mass within said second collection box.

6. The multi-pass fryer heat exchanger according to claim 5, wherein said first thermal mass and said second thermal mass is a dissimilar material from said plurality of first pass tubes, said at least one second pass tube, said at least one third pass tube, said first collection box and said second collection box.

7. The multi-pass fryer heat exchanger according to claim 1, wherein said at least one second pass tube is located below said plurality of first pass tubes.

8. The multi-pass fryer heat exchanger according to claim 7, wherein said at least one third pass tube is located below said at least one second pass tube.

9. The multi-pass fryer heat exchanger according to claim 1, wherein said plurality of first pass tubes include at least one baffle located within a length of each of said plurality of first pass tubes.

10. The multi-pass fryer heat exchanger according to claim 1, wherein said first thermal mass is carbon steel.

11. The multi-pass fryer heat exchanger according to claim 10, wherein said thermal mass has a volume of between 10 and 100 cubic inches.

12. The multi-pass fryer heat exchanger according to claim 11, wherein said thermal mass is heated by a heat that is produced in said flame tube and is configured to dissipate heat stored in said thermal mass when said heat is not being produced in said flame tube.

13. The multi-pass fryer heat exchanger according to claim 1, wherein a cross-sectional area of said at least one second pass tube is less than a cross-sectional area of said plurality of first pass tubes.

14. The multi-pass fryer heat exchanger according to claim 13, wherein a cross-sectional area of said at least one third pass tube is less than a cross-sectional area of said least one second pass tube.

15. The multi-pass fryer heat exchanger according to claim 1, wherein there are four first pass tubes.

16. The multi-pass fryer heat exchanger according to claim 15, wherein three second pass tubes.

17. The multi-pass fryer heat exchanger according to claim 16, wherein there are two third pass tubes.

18. The multi-pass fryer heat exchanger according to claim 1, wherein a flue product through said plurality of first pass tubes is combined in said first collection box.

19. The multi-pass fryer heat exchanger according to claim 1, wherein each of said plurality of first pass tubes has a separate said flame tube;

20. The multi-pass fryer heat exchanger according to claim 1, wherein multi-pass fry heat exchanger is configured to heat an oil vat.
